(19) United States
(12) Patent Application Publication
(10) Pub. No.: US 2014/0347032 A1
(43) Pub. Date: Nov. 27, 2014

(54) CHIP DETECTOR

(71) Applicant: Caterpillar Inc., Peoria, IL (US)

(72) Inventors: Daniel J. Reed, Brimfield, IL (US); Timothy F. Nusz, Wyoming, IL (US)

(73) Assignee: Caterpillar Inc., Peoria, IL (US)

(21) Appl. No.: 14/457,555

(22) Filed: Aug. 12, 2014

(51) Int. Cl. G01V 3/08

(52) U.S. Cl. CPC G01V 3/08
USPC 324/71.1

(57) ABSTRACT

A chip detector includes a plug configured to be coupled to a housing. The plug includes a first magnetic member and a second magnetic member spaced apart from each other so as to define a gap therebetween. Each of the first magnetic member and the second magnetic member is a rare earth magnet. A first electric contact is electrically coupled with the first magnetic member and a second electric contact is electrically coupled with the second magnetic member. A resistor is electrically coupled between the first electric contact and the second electric contact. An energy storage device is configured to provide a voltage difference between the first electric contact and the second electric contact. An indicating member is configured to provide an indication of a flow of current between the first and second electric contacts due to collection of chips in the gap between the first and second magnetic members.

### TECHNICAL FIELD

The present disclosure relates to a chip detector.

### BACKGROUND

Machine components, such as motors, hydraulic systems and transmissions include rotary parts, such as gears or bearings. Such rotary parts are generally made up of metal and are immersed in liquids such as lubricants, coolants etc. to dissipate heat within the system, and to reduce the wear of the system components.

However, wear of one or more system components may normally occur during operation. Increased wear of the system components may lead to particulate matter detaching from the system component and entrained in the surrounding liquid. Detection of such particulate matter may be desirable for estimating when the system components are approaching failure and requires maintenance and/or replacement of machine component.

U.S. Pat. No. 2,878,342 (the '342 patent) describes a magnetic chip detector including a tubular plug which is electrically conductive, a permanent magnet located therein and spaced therefrom, and an insulating material in the space between the two. A terminal screw is provided in the plug and insulated therefrom, the screw having a head within the plug, one pole end of the magnet contacting the head, the magnet having an upwardly facing upper end, the plug having downwardly facing portions associated therewith to retain the insulating material and thereby the magnet in the plug and in contact with the terminal screw head, the other pole end of the magnet and the adjacent end of the plug constituting opposed magnetic poles to attract ferrous particles which may bridge the insulating material.

However, a source of current and a light bulb of the magnetic chip detector of the '342 patent may be located remote to the chip locator and electrically connected via wires. Such wires may be difficult to be used with rotating components. Further, the wires may be susceptible to damage.

### SUMMARY OF THE DISCLOSURE

In one aspect of the present disclosure, a chip detector is provided. The chip detector includes a plug configured to be coupled to a housing. The plug has a first magnetic member and a second magnetic member. The second magnetic member is spaced apart from the first magnetic member so as to define a gap therebetween. Further, each of the first magnetic member and the second magnetic member is a rare earth magnet. The chip detector further includes a first electric contact electrically coupled with the first magnetic member and a second electric contact electrically coupled with the second magnetic member. The chip detector also includes a resistor electrically coupled between the first electric contact and the second electric contact. The chip detector includes an energy storage device configured to provide a voltage difference between the first electric contact and the second electric contact. The chip detector further includes an indicating member configured to provide an indication of a flow of current between the first electric contact and the second electric contact due to collection of chips in the gap between the first magnetic member and the second magnetic member.

Other features and aspects of this disclosure will be apparent from the following description and the accompanying drawings.

### BRIEF DESCRIPTION OF THE DRAWINGS

FIG. 1 is a perspective view of a chip detector according to an embodiment of the present disclosure;

FIG. 2 is a bottom view of the chip detector of FIG. 1, according to an embodiment of the present disclosure;

FIG. 3 is a sectional view of the chip detector of FIG. 1 taken along line A-A′ of FIG. 1, according to an embodiment of the present disclosure;

FIG. 4 is a sectional view of the chip detector installed on a machine component, according to an embodiment of the present disclosure; and

FIG. 5 is a sectional view of the chip detector of FIG. 4 in an operating state, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

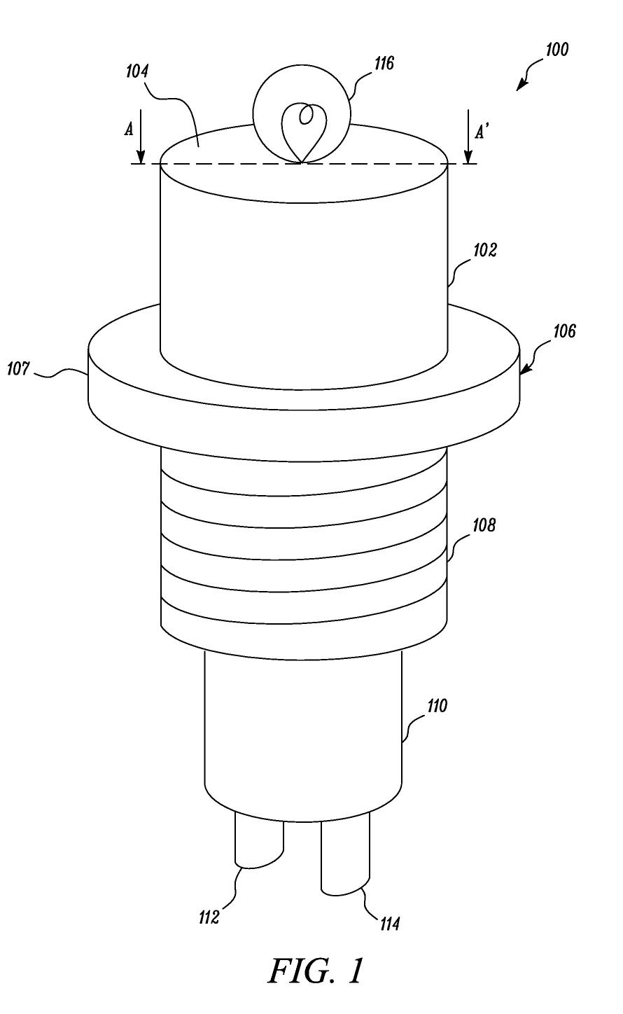

FIG. 1 describes a chip detector 100, according to an embodiment of the present disclosure. The chip detector 100 includes a top portion 102 having a top surface 104. The top portion 102 is coupled to a plug 106. The plug 106 includes a flange portion 107 and a securing portion 108. In an embodiment, the securing portion 108 includes threads. In an alternative, the securing portion 108 may include any other securing arrangements like snap-fit members, teeth, radial extensions, and the like. The chip detector 100 further includes a bottom portion 110 extending from the securing portion 108. The chip detector 100 includes a first magnetic member 112 and a second magnetic member 114 extending from the bottom portion 110. The chip detector 100 further includes an indicating member 116. The indicating member 116 is disposed on the top surface 104 of the top portion 102.

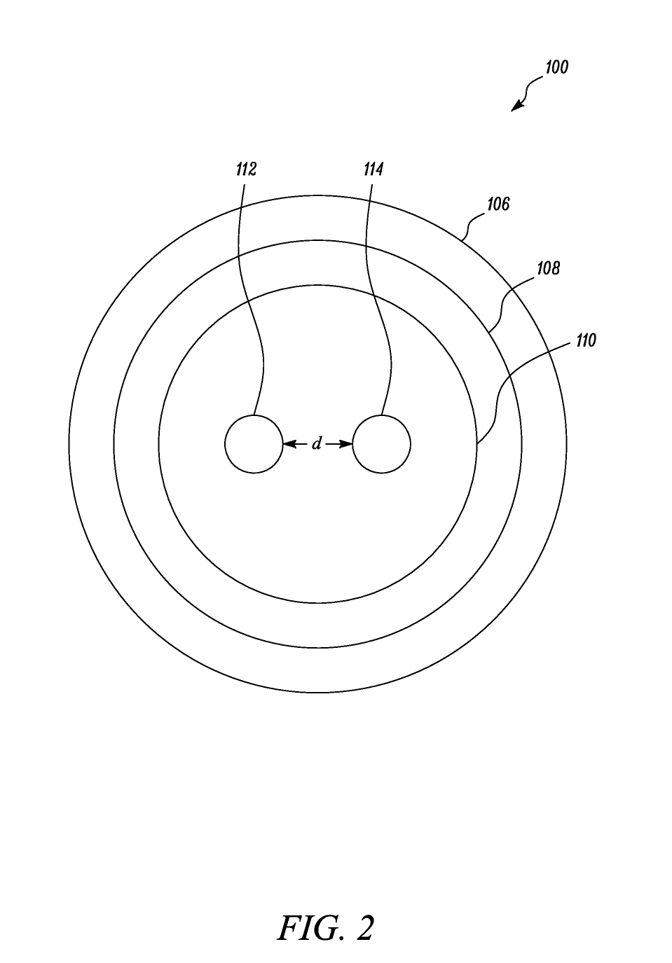

FIG. 2 describes a bottom view of the chip detector 100, according to an embodiment of the present disclosure. As shown in FIG. 2, the first magnetic member 112 and the second magnetic member 114 are spaced apart from each other and define a gap (d) between them. The gap (d) may be a minimum distance between the first and second magnetic members 112, 114. Further, the first magnetic member 112 and the second magnetic member 114 are substantially cylindrical. However, in other examples, first magnetic member 112 and the second magnetic member 114 may have any alternative shape, for example, polygonal, curvilinear, and the like. Further, length of the first magnetic member 112 and the second magnetic member 114 may be dependent on the gap (d). In an example, ratio of the length of the first magnetic member 112 or the second magnetic member 114 to the gap (d) may lie in a range from about 3 to 4. Further, a length of the gap (d) may be such that no arcing occurs between the first magnetic member 112 and the second magnetic member 114.

In an embodiment, each of the first magnetic member 112 and the second magnetic member 114 is a rare earth magnet. Rare earth magnets are permanent magnets made of one or more rare earth elements or alloys thereof. Rare earth magnets may have stronger magnetic field compared to other types of permanent magnets, such as ferrite magnets. In an example, the first and second magnetic members 112, 114 may be neodymium based magnets or samarium-cobalt based magnets. Further, the first and second magnetic members 112, 114 may be plated or coated to safeguard the magnetic substrate from corrosion and breakage.

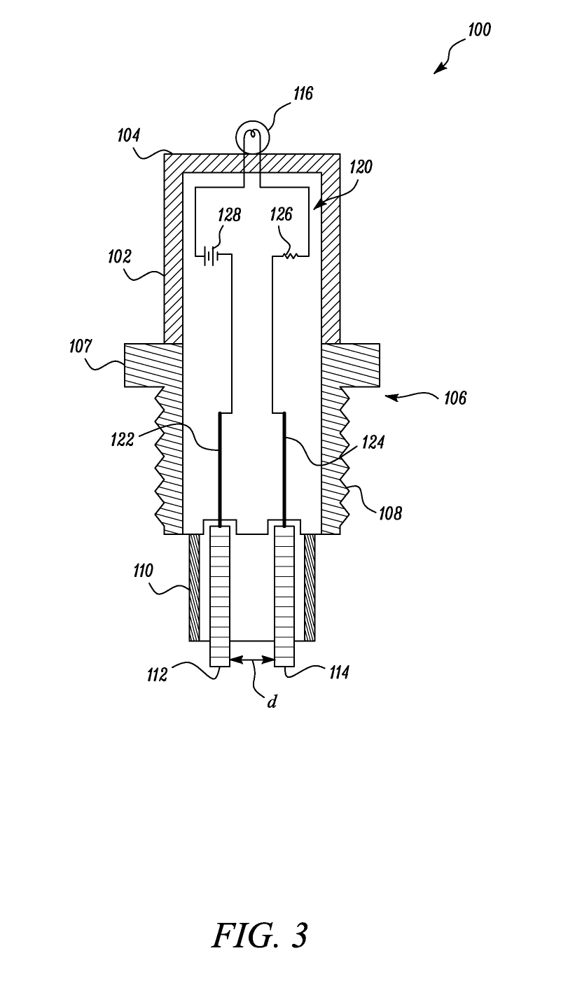

FIG. 3 describes a sectional view of the chip detector 100 taken along line A-A′ of FIG. 1, according to an embodiment of the present disclosure. As shown in FIG. 3, the chip detector 100 includes an electric circuit 120 housed within the top portion 102 and the plug 106. Various components of the electric circuit 120 are shown schematically for illustrative purpose. The electric circuit 120 includes a first electric contact 122 electrically coupled with the first magnetic member 112, and a second electric contact 124 electrically coupled with the second magnetic member 114. In an embodiment, the first magnetic member 112 and the second magnetic member 114 are electrically conductive. Further, the first and second electric contacts 122, 124 may be any electrically conductive material. In an embodiment, the first magnetic member 112 and the second magnetic member 114, and the first electric contact 122 and the second electric contact 124 are electrically insulated from each other via an insulating material (not shown). The insulating material may be non-magnetic and non-conducting.

The electric circuit 120 further includes a resistor 126. The resistor 126 is electrically coupled between the first electric contact 122 and the second electric contact 124. The electric circuit 120 further includes an energy storage device 128 electrically coupled between the first electric contact 122 and the second electric contact 124. As shown in FIG. 3, the energy storage device 128 may be connected in series with the resistor 126. The energy storage device 128 is configured to provide a voltage difference or potential difference between the first electric contact 122 and the second electric contact 124. In an embodiment, the energy storage device 128 is a direct current (DC) power source, for example, a cell, a battery, or the like. A resistance value of the resistor 126 may and/or a voltage output of the energy storage device 128 may depend on operating parameters of the indicating member 116, for example, power requirement.

The electric circuit 120 further includes the indicating member 116. The indicating member 116 is electrically coupled between the first electric contact 122 and the second electric contact 124. The indicating member 116 may be connected in series with the resistor 126 and the energy storage device 128. The indicating member 116 is configured to provide an indication of a flow of current between the first electric contact 122 and the second electric contact 124. In an embodiment, the indicating member 116 is a Light Emitting Diode (LED). In other examples, the indicating member 116 may be an audio device, a tactile feedback device, a display device, or a combination thereof. In an example, the indicating member 116 may be a buzzer.

It may be apparent to a person ordinarily skilled in the art that the gap (d) prevents a flow of current between the first and second magnetic member 112, 114, and hence the first and second electric contacts 122, 124. Thus, normally the electric circuit 120 is an open circuit and no current flows therethrough. However, in case the electric circuit 120 becomes complete due to accumulation of electrically conductive material in the gap (d) between the first and second magnetic members 112, 114, current may flow in the electric circuit 120 due to the potential difference between the first and second electric contacts 122, 124.

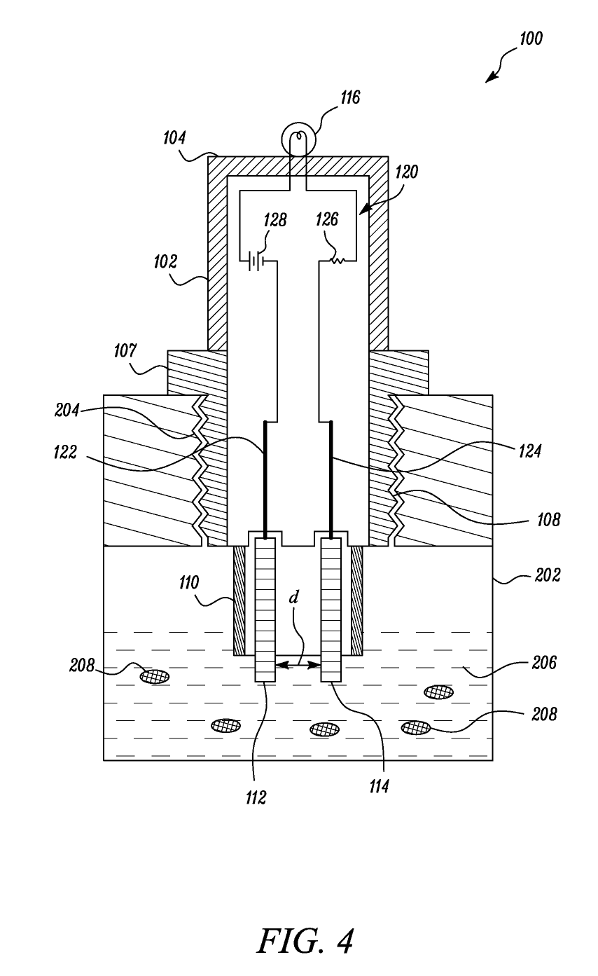

FIG. 4 illustrates the chip detector 100 is installed on a housing 202 of a machine system. The housing 202 includes a receiving portion 204. The receiving portion 204 includes internal threads. The receiving portion 204 is configured to at least partly receive the chip detector 100 therein. Further, the external threads on the securing portion 108 of the plug 106 may mate with the internal threads of the receiving portion 204. In various embodiments, one or more sealing members (not shown) may be provided between the securing portion 108 and the receiving portion 204 to achieve a fluid tight arrangement. In other examples, the chip detector 100 may be coupled to the housing 202 other via a quick coupling or a snap-fit coupling. The chip detector 100 may also be connected to the housing 202 by any other methods known in the art, for example, press-fitting, welding, adhesives etc.

The housing 202 of the machine component may enclose one or more rotary parts (not shown). In an embodiment, the housing 202 may also rotate during operation. The rotary parts may include gears, bearings, shafts, couplings, or the like. The housing 202 further stores a liquid 206 therein. The liquid 206 may a lubricant, a coolant, a hydraulic fluid or a combination thereof. In an embodiment, the liquid 206 may be oil. The rotary parts are immersed in the liquid 206. During operation, wear of the rotary parts may lead to formation of metallic particles or chips 208. The chips 208 may get entrained within the liquid 206. The chips 208 may be electrically conductive.

As shown in FIG. 4, the chip detector 100 may be installed on the housing 202 such that the first and second magnetic members 112, 114 extend into the housing 202 and are at least partly immersed in the liquid 206. As explained earlier, the chip detector 100 is secured to the housing 202 in a fluid tight arrangement to substantially prevent any leakage of the liquid 206. Further, the gap (d) between the first magnetic member 112 and the second magnetic member 114 may cause the electric circuit 120 to be an open circuit.

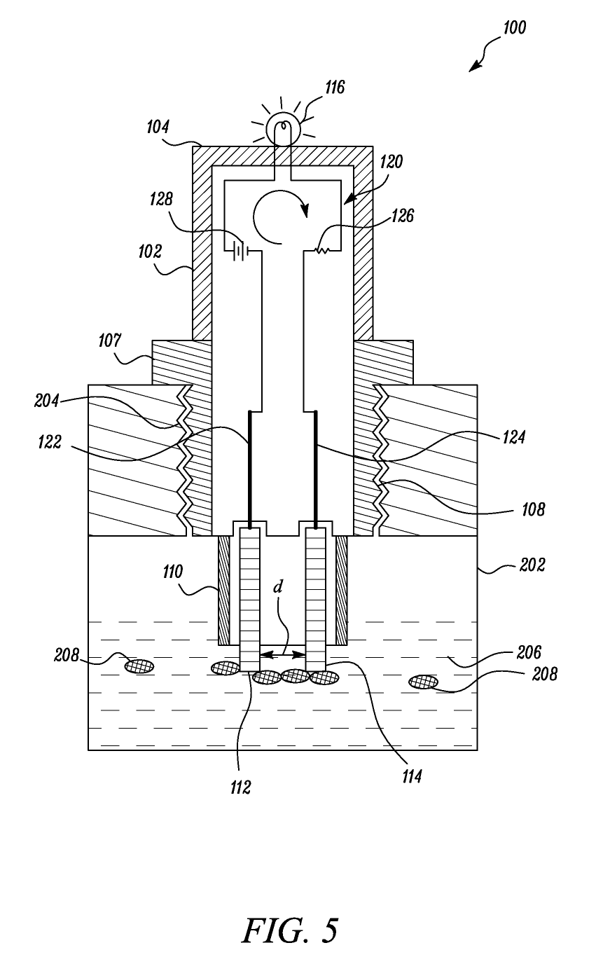

FIG. 5 illustrates the chip detector 100 in an operating state, according to an embodiment of the present disclosure.

The first magnetic member 112 and the second magnetic member 114 may magnetically attract one or chips 208 entrained in the liquid 206. The first and second magnetic members 112, 114 may have sufficient magnetic strength to attract the chips 208 without requiring any additional energy.

As shown in FIG. 5, the chips 208 may tend to accumulate in the gap (d) between the first magnetic member 112 and the second magnetic member 114. The chips 208 may provide a path for current to flow between the first and second magnetic members 112, 114. Thus, the electric circuit 120 may become a closed circuit. This may enable current to flow through the electric circuit 120.

Current flowing through the electric circuit 120 may activate the indicating member 116. Therefore, the indicating member 116 may provide a signal indicative of a flow of current between the first and second electric contacts 122, 124 due to collection of the chips 208 in the gap (d). In case the indicating member 116 is embodied as a Light Emitting Diode (LED), illumination of the indicating member 116 may provide a visual signal indicative of detection of the chips 208.

### INDUSTRIAL APPLICABILITY

The present disclosure is related to a chip detector 100. The chip detector 100 may be secured to a housing 202 of a machine component. The machine component may be part of any machine used in various industries, for example, construction, agriculture, mining, transportation, power generation etc. The housing 202 may enclose rotary parts immersed in a liquid 206. Further, the housing 202 may also be rotatable during operation. Due to wear of the rotary parts, chips 208 may be formed and entrained in the liquid 206. The chip detector 100 is configured to detect the chips 208 within the housing 202.

Due to presence of the voltage difference across the electric circuit 120, current begins to flow through the electric circuit 120. Current activates the indicating member 116. The indicating member 116 thus provides a signal indicative of detection of the chips 208 in the liquid 206 of the housing 202. As explained earlier, the indicating member 116 may be a Light Emitting Diode (LED), and illumination of the indicating member 116 is the signal indicative of detection of the chips 208.

As described earlier, the first magnetic member 112 and the second magnetic member 114 are rare earth magnets and have high magnetic strength as compared to conventional permanent magnets. Hence, the first and second magnetic members 112, 114 may be able to magnetically attract the chips 208 more effectively without requiring any additional energy source. Further, various components of the electric circuit 120, including the energy storage device 128 and the indicating member 116, may be disposed within the chip detector 100. The chip detector 100 may therefore not require any external wires for connection to remotely located components. Thus, the chip detector 100 may be mounted on machine components with rotatable housings. Further, any damage related to external wires may also be prevented. Moreover, the chip detector 100 may have a compact configuration facilitating usage in applications with space constraints. The chip detector 100 may also be used as a portable device which may be detachably mounted on various machine components for chip detection.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A chip detector comprising:
a plug configured to be coupled to a housing;
a first magnetic member extending from the plug;
a second magnetic member extending from the plug, the second magnetic member spaced apart from the first magnetic member so as to define a gap therebetween, wherein each of the first magnetic member and the second magnetic member is a rare earth magnet;
a first electric contact electrically coupled with the first magnetic member;
a second electric contact electrically coupled with the second magnetic member;
a resistor electrically coupled between the first electric contact and the second electric contact;
an energy storage device configured to provide a voltage difference between the first electric contact and the second electric contact; and
an indicating member configured to provide an indication of a flow of current between the first electric contact and the second electric contact due to collection of chips in the gap between the first magnetic member and the second magnetic member.
